(19) United States
(12) Patent Application Publication
(10) Pub. No.: US 2014/0359784 A1
(43) Pub. Date: Dec. 4, 2014

(54) Method of Anonymising an Interaction Between Devices

(71) Applicant: Really Virtual Company Limited, London (GB)

(72) Inventors: John Graham Taysom, London (GB); David Cleevely, Cambridge (GB)

(21) Appl. No.: 14/462,318

(22) Filed: Aug. 18, 2014

Related U.S. Application Data
(63) Continuation-in-part of application No. 12/745,313, filed on Dec. 21, 2010, now Pat. No. 8,812,372.

(30) Foreign Application Priority Data
Nov. 28, 2007 (GB) 0723276.2

(51) Int. Cl. G06F 21/62

(52) U.S. Cl. CPC G06F 21/6254; G06F 21/6263
USPC 726/26

(57) ABSTRACT

A method is provided of anonymising an interaction between a user entity and a service provider node wishing to provide a service to the user entity in dependence upon characteristics of the user entity determined or revealed as a result of the interaction, the method comprising: assigning the user entity to at least one set, each set comprising as members a plurality of user entities sharing a characteristic associated with that set; counting the number of user entities the set or in an intersection of the at least one set and calculating a share of said value attributable to each user by dividing the value by the number of user entities in the set; ensuring that the intersection of the at least one set comprises at least a predetermined minimum number of user entities; and providing to the service provider node information relating to the or each characteristic associated with the at least one set, the information being for use at the service provider node in providing a service to the user entity that is appropriate in view of the characteristics of the user entity but insufficient to identify the user entity.

### RELATED PATENT DATA

This application is a continuation-in-part of and claims priority to U.S. patent application Ser. No. 12/745,313, which was filed Dec. 21, 2010, which is a 35 U.S.C. §371 of and claims priority to PCT International Application Number PCT/GB2008/051132 (Publication No. WO 2009/068917A2), which was filed 28 Nov. 2008 (18.11.08), and was published in English, and this application claims priority to GB Patent Application No. 0723276.2 which was filed 28 Nov. 2007 (28.11.07), and the teachings of which are incorporated herein by reference.

### TECHNICAL FIELD

The present invention relates to a method of anonymising an interaction between entities such as devices and/or people.

### BACKGROUND

Interactive systems, whether for humans or machines, typified by the example of the internet, but also more generally for any interactive system linking people and machines, for example mobile telephone services, “Internet of Things” services and devices, provide a level of personalisation by observing and recording the behaviour of an individual. Sometimes this is done by lodging in a central database, or in a hierarchy of multiple databases, data that has been observed on behaviour and preferences of users.

A typical system might log the IP address, or equivalent logical network address, of a user machine or application, and recognise that real (or virtual) “user” on return. More sophisticated systems might leave a portion of the activity database, for example the piece of code often referred to as a “cookie”, on the user's machine, or lodged in some interim database or databases between the user application and the ultimate host for that application, or in some interim relay application. Some systems might recognise a user from a ‘fingerprint’ or unique characteristic of their device or pattern of usage.

In this way the ultimate host application or applications and databases associated with it, records information on behaviour and preferences in between visits to the host machine, service or application. The user is therefore identifiable and can be identified specifically, or inferred with a high degree of accuracy.

The user, whether human or machine, of services provided across the network accepts, typically by default but sometimes explicitly, to be identified in order to be offered tailored information, including the offer of possible transactions which then require the further provision of specifically personal data such as credit card information.

Sometimes, for example when accessed from a company or a specific Internet Service Provider (ISP), there is an accidental level of anonymity provided for the end user. For example, the host sees only that the user has arrived from AOL® or from within IBM®, but increasingly systems serving content look beyond this to identify the user machine or user specific application to the host application.

In the case of mobile phones, specific identification of the handset is required to enable the call to take place (and in future this specific identification will extend to the applications running in the handset). Often the user is asked for further information to be volunteered and this allows greater tailoring in exchange for less privacy.

Anonymous web access is already possible using a proxy server or anonymiser service but then there is no possibility for the provision of tailored services to that real or virtual “user”. These services may be the provision of content for humans, or may be privileged computing and bandwidth services or perhaps tailored information services or access rights or commercial offers including direct marketing or advertising offers, or other types of data or media content.

If the user uses an existing proxy machine or an existing anonymiser service they can be anonymous but they then forgo any systematic chance of a tailored or personalised response from the service or machine or application. This may be as simple as forgoing preferential access speeds, or as complex as being unable to access specific personalised and private information that is unique to the user.

Furthermore, the interaction with a user or users can be valuable to a service provider in terms of information that relates to the user(s) that can be provided to the service provider.

The invention has been devised with the foregoing in mind.

### SUMMARY

According to a first aspect of the present invention there is provided a method of anonymising an interaction between a user entity comprising a computing device and a service provider node wishing to provide a service via a network to the user entity in dependence upon characteristics of the user entity determined or revealed as a result of the interaction, said interaction having a value associated therewith, the method comprising: assigning the user entity to at least one set, each set comprising as members a plurality of user entities sharing a characteristic associated with that set; counting the number of user entities in a said set and calculating a share of said value attributable to each user by dividing the value by the number of user entities in the set or in the intersection of the at least one set; ensuring that said set or the intersection of the at least one set comprises at least a predetermined minimum number of user entities; and providing to the service provider node, as part of the interaction, information relating to the or each characteristic associated with each set, the information being for use at the service provider node in providing the service to the user entity, as part of the interaction, that is appropriate in view of the characteristics of the user entity but insufficient to identify the user entity, wherein the assigning, ensuring and providing steps are performed at an anonymiser system disposed on a communication path between the user entity and the service provider node, the anonymiser system comprising a cooperation of nodes, wherein anonymised service is provided to the user entity via the anonymiser system as part of the interaction between the user entity and the service provider.

The method may comprise populating at least one set with dummy user entities to ensure that the intersection comprises at least the predetermined minimum number of user entities.

The method may comprise populating at least one set with additional user entities and/or one or more additional sets of user entities to ensure that the interaction comprising at least the predetermined minimum number of entities.

The method may comprise merging two sets to create a larger set. This makes identifying a user entity more difficult. The second set merged may be of a size that minimises the total number of user entities in the new merged set. The size of the second set may be determined in real-time and/or dynamically during use, so that the set size need not be fixed. The method may iteratively identify the smallest additional set to add to the target set to re-establish adequate measurable privacy.

The method may prevent subdivisions of sets.

The method may enable users or services to identify some characteristics that cannot be used to create clusters.

The method may comprise presenting a warning at the user entity if the intersection comprises a number of user entities within a predetermined range.

An information broker node may communicate with a clustering engine node to determine the at least one set to be assigned to the user entity, with the clustering engine node having knowledge of membership of the sets and the information broker node providing to the clustering engine node information sufficient to assign the user entity to the at least one set.

The clustering engine node may act on abstractions of identities the translation of which to real identities is not known by the clustering engine node.

The information broker node may maintain information sufficient to identify the user entity without retaining knowledge of the characteristics of the user entity that are passed to the clustering engine.

The information broker node may be distributed across a plurality of nodes. This may provide an improvement in performance, reduce the attack surface, or both.

The method may comprise maintaining a record of user entity membership for each set, and updating the membership of the at least one set when the user entity is assigned to the at least one set.

At least some of the steps may be performed at a node, or a cooperation of nodes, disposed on a communication path between the user entity and the service provider node.

The service may be provided to the user entity via the node or cooperation of nodes.

The method may comprise, on request of the user entity, allowing the user entity to be identified to another user entity in the at least one set.

The method may comprise, on request of the user entity, allowing the user entity to be identified to the service provider node.

The method may comprise providing a service to the user entity in dependence upon the information.

The service may comprise sending data to the user entity.

The data may comprise media content.

The data may comprise advertising content.

The predetermined minimum number may be at least two, at least three, at least ten, or at least 100.

The method may comprise determining the predetermined number in real-time and/or dynamically during use, so that the predetermined number need not be fixed.

The user entity may be a person or a person utilising one or more devices, or may be or comprise one or more devices. The interaction may involve a plurality of providers of different services. Each service provider may be directly involved with the user in the interaction. In addition or alternatively, each service provider may already hold information on the user entity. This information may have been gathered in prior interactions, or may have been acquired through other routes with the intention of better identifying an individual in a subsequent interaction.

The characteristics may comprise at least one of the hardware capabilities of the device, software capabilities of the device, and location of the device.

The user entity may comprise a user of the device.

The user entity may comprise a user of a device.

The characteristics may comprise personal information relating to the user, such as an indication of at least one of the age, gender, health details, medical treatment, home address, postcode, salary, likes, and dislikes of the user, genetic data, physical appearance, movement or physical behavioural characteristics, key words used in communications by the user, energy usage.

According to a second aspect of the present invention there is provided an apparatus for anonymising an interaction between a user entity comprising a computing device and a service provider node wishing to provide a service via a network to the user entity in dependence upon characteristics of the user entity determined or revealed as a result of the interaction, said interaction having a value associated therewith, the apparatus comprising: an anonymiser system configured to assign the user entity to at least one set, each set comprising as members a plurality of user entities sharing a characteristic associated with that set; a counting engine being configured for counting the number of user entities in a said set and calculating a share of said value attributable to each user by dividing the value by the number of entities in the set; the anonymiser system being configured to ensure that the set or the intersection of the at least one set comprises at least a predetermined minimum number of user entities; and the anonymiser system is configured to provide to the service provider node, as part of the interaction, information relating to the or each characteristic associated with each set, the information being for use at the service provider node in providing the service to the user entity, as part of the interaction, that is appropriate in view of the characteristics of the user entity but insufficient to identify the user entity, wherein the anonymiser system is disposed on a communication path between the user entity and the service provider node, wherein anonymised service is provided to the user entity via the anonymiser system as part of the interaction between the user entity an the service provider.

According to a third aspect of the present invention there is provided a program for controlling an apparatus to perform a method according to the first aspect of the present invention, or which when loaded into an apparatus causes the apparatus to become apparatus according to the second aspect of the present invention.

The program may be carried on a carrier medium.

The carrier medium may be a storage medium or it may be a transmission medium.

According to a fourth aspect of the present invention there is provided an apparatus programmed by a program according to the third aspect of the present invention.

According to a fifth aspect of the present invention there is provided a storage medium containing a program according to the third aspect of the present invention.

The counting engine may keep a record of the number of user entities. The counting engine may be part of the clustering engine. A subroutine in the clustering engine may check that the clusters/sets are large enough, by subjecting the clusters characteristic to formal tests.

Methods, processes and mechanisms are provided to enable users of interactive computer and communication systems to achieve the benefits of personalisation without the problem of revealing their identity to other humans or to intermediate machines by the provision of one or more ‘anonymiser’ systems and applications working in conjunction with one or more ‘grouping engines’ and working with an information broker which is independent of both the anonymiser system and the clustering function.

In the above described aspects and embodiments, the interaction may have a monetary value associated therewith or be associated with a monetary value. Furthermore, the ‘counting’ method/process/mechanism enables user entities, who remain anonymous to a service provider, to be rewarded for their involvement in the interaction and receive a share of the total worth of the interaction in money or money's worth (e.g. loyalty points, air miles etc.).

The use of these three logical components in combination and the methods and processes employed in their deployment are novel and in their implementation provide a technical benefit from a computing and communication perspective.

For the aspects and embodiments described herein, the anonymiser system comprises one or more information brokers and one or more clustering engines together with an anonymiser configured to test the size of the set/cluster (as will be described further below).

### BRIEF DESCRIPTION OF THE DRAWINGS

FIG. 1 is a schematic illustration of an embodiment of the present invention.

### DETAILED DESCRIPTION

As mentioned previously, if a user uses a proxy machine or an anonymiser service they can be anonymous but they then forgo any chance of a tailored or personalised response from the service or machine or application.

In order to obtain the benefits of personalisation without the potential for intrusion, an independent information brokerage service as part of the anonymising system is provided in an embodiment of the present invention. This service enables the user to deal only with it, the broker, alone and it deals uniquely on behalf of the user with any request for or provision of information.

The information brokers are in a privileged position of trust with both the user and the host application and/or service, and the agreement (explicit or implicit) of both to trust the brokers is required.

Once the broker has been identified as trusted by the host and the user has volunteered to use it and therefore agreed to trust it, it is proposed in a method embodying the present invention that the user is never individually identified to the host machine for the service or application being provided. The user is only ever identified as part of a group of similar or like individuals.

Similar or “like” users are grouped by the grouping engine, whereby each group is never less than, say, two or three to ensure anonymity, but may be more than, say, two or three where required.

The user may be offered the chance to choose the level of grouping: for example never less than two, three, 30, or 300, depending on the level of personalisation required and the level of obfuscation of their identity required for that application. This level need not be fixed but may be determined dynamically or in real-time during use, to ensure that a measured level of privacy is maintained.

The group management processes use set theory and advanced clustering information technology and mechanisms to ensure that adequate numbers are in the group to ensure continued privacy. This is likely to be dynamic and interactive with the user, in real-time, who would be warned when they are in danger of stepping out of that ‘crowd’, though the user can chose to do so if they wish (unless they have signed up not to be allowed that right—for example for parental control over their children's activity on-line). The individual user identity is therefore “lost in a crowd” of other users. The size of the crowd may be variable depending on the application. Group membership of the user may change and be, in effect, a series of mappings or pseudo or temporary groups imposed for a transaction or transaction for a period of time.

The users in each group may remain anonymous to each other or may choose to be identified to each other for some purposes but not others. For example the user may wish to buy a concert ticket for the Glastonbury festival. Initially unknown to them, they may be in a group of ten users from Putney attending the concert. They may choose to allow other group members in the cluster, previously unknown to each other, to message them to arrange a ride-share.

In order to comply with information access laws and regulations and to provide an audit trail the full details of group membership are maintained in the information broker but are only ever accessible to an external independent audit firm or equivalent. The clustering engine and the broker are separate processes and abstracted information from the clustering engine may be used by the broker and vice versa but they never exchange enough information to allow the role of independent broker to be compromised.

An analogue of this system, which is dynamic in principle but which changes only rarely because it is based on physical buildings and households, is the Zip code or Post Code system. This system groups people by residential or commercial geographic location only.

A zip code represents a group of people who have potentially no other group affiliation other than location. But they may be in that location because of schools and therefore share other characteristics like children of school age. They may be involved in activities involving for example the sea, or the mountains, depending on the location. Their behaviours may map them to hundreds of groups to which their affiliation may be only momentary or life-long. However, if a Venn diagram were drawn of all characteristics of that individual and his neighbours, eventually the addition of characteristics, or dimensions, would allow identification of the individual. On the other hand, in some cases, and for some characteristics, although they may think of themselves as quite unique in their likes and behaviours in fact they may be like many similar people in the same zip code and, even if they are unique in their zip code, there are others just like them in other zip codes. By aggregating or clustering the similar individuals into larger

groups, eventually their privacy can be reestablished in that reidentification becomes difficult again. Here, all that has been relaxed is the dimension of location which, for other zip codes, may have a minimal negative impact on the economic value of the cluster size. As such, it can be said that maximizing economic value subject to the constraints of always ensuring adequate privacy could be an objective of one or more services using the methods described herein.

In order to benefit from special directed messages or privileges it may not be necessary to take the path taken by on-line technology today: they may have the option without compromising the benefits they receive to remain lost in a crown of thousands and have no need give up their identity to receive those benefits; mortgage offers to Fulham (London, England) residents for amounts greater than £1M, for example. Once the offer has been targeted, the user may then decide to enter into a transaction, during the course of which they may choose to reveal their specific identity. But they know to whom they have provided that information, and for what purpose and in what context.

Some data on individuals may be held in personal data stores and not at the service provider. The method enables users with personal data stores under their control for their own data alone to safely co-mingle that data with data from others either contained in personal data stores on their own devices or in the cloud or held at the service provider.

The population associated with each zip code and post code would never usually be fewer than a predetermined level to ensure anonymity. The analogy is not perfect but serves to illustrate the concept.

Anonymiser services exists for human activity, at least on the Web. These services merely replace one identification with an intermediate identification, where the mapping is one-to-one. What is novel in an embodiment of the present invention is to extend this concept to both traceable pseudonymous activity, and to machine interactions in a network and to behavioural data gathered from mobile networks for humans, as is the manner in which an interaction is actually anonymised.

Versions of clustering engines exist to cluster known identities and their characteristics, but not in the context of anonymising interactions and communications between devices. A version to retain the identity within an ID brokerage context is novel. A user may be alone in a cluster group but their identity as the sole occupant is never known to the service. Clusters may be ‘pre-prepared’ with dummy members before adding real users who are observed to exhibit a characteristic to ensure that there is more than one member to a cluster, or dummy members may be added during use as required. The clustering is done on abstractions of identities the translation of which to real identities is not known to the clustering engine or its operators, human or machine. Clustering can be in real time or batched into runs. The data that represents the characteristic(s) of a user entity may be “observed” in the sense that it already exists and is known to the information browser node, or “volunteered” by a user entity as part of the interaction. The latter thus provides for transaction data capture. The cluster is therefore a record of observed or declared preferences relating to a user entity.

The following example is provided by way of further explanation. Consider an individual who lives in Putney (London, England), has had an interest in double glazing, an interest in dogs, and an interest in Mercedes cars. This makes the individual a member of a set of individuals and no further knowledge of identity is needed to advertise to them a wide range of products. That they also have an interest in crèches and rugby, an interest in Bach and Tuscany may still not be enough to allow insight to identify the individual. Add to this an interest in childhood eczema and it might identify just one family. Widen the clustering to include neighbouring Wandsworth, and the ‘crowd’ is restored and hence privacy also. Dummy members of the group(s) can be added to ensure there is no chance that individual IDs are compromised. The ‘services’ never learn the identities of the users (human or machine). Embodiments of the invention thus extend to business-to-business (b2b) interactions that can access information relating to a user entity as part of an interaction, but without knowledge of the identity of that user entity. Provision of credit scores is an example.

For example, a service might be provided by a service provider that connects to a user entity and collects information from that transaction, and/or connects to another service provider who already holds information about that user entity. Or, it might connect to a service provider that holds data about user entities which it has gathered for other reasons. For example, a billing database for smart metered energy or for telecom mobile minutes not only holds information that can be used to invoice telecom users, it can also reveal information in the abstract about telecom users that can be valuable to the service provider.

In this sense the “user” may not be a retail individual “user”. A “user” may be an individual person or a single device, but importantly may also be an intermediate entity or process. For example, if the service was to provide to a mobile telecom operator a privacy-aware way to provide targeted advertisements to a mobile phone user, the service might connect to their online databases, collected for another use, and also to the retail individual human end user. Or it might be entirely “offline” with respect to the individual retail human user, in which case the “user” is the mobile telecom operator and not the human end user of the mobile telecom operator's services. Embodiments of the invention thus provide a novel approach to privacy-preserving data mining by providing context-aware, real-time and/or dynamic privacy-preserving data mining, for example for Internet of Things applications.

For example, a mobile telecom operator provides services to customers (user entities) and collects data about those user entities, and subsequently ascertains that the data collected is more valuable to them than initially thought. The information collected (e.g. where the user entity is calling from, how many times they call a particular restaurant) provides useful additional marketing material and opportunities. Provided the mobile telecom operator can ensure privacy/anonymity of the user entities, this opens up new marketing opportunities that were not previously available to them. Thus, here, the mobile service provider is the principal potential monetary beneficiary of the anonymity provided, in addition to the user entity whose identity remains unknown to them. This thus provides a valuable by-product (marketing) of the service being provided (telecoms).

Versions of information brokers exist but typically the broker retains the knowledge of the relevant characteristics of the individuals.

Some commercial and nfp (not for profit) examples of personal data stores exist but they silo an individual's data with the intention of giving the individual control over the use of the data. Embodiments of this invention allow data managed in this way to be safely co-mingled to derive valuable insights about groups of users in a privacy-preserving manner. They further allow an individual access to the monetary value of the group of which they are members, which is often greater than the value of their data when isolated.

The brokerage function can be distributed throughout the network to enable fast response times.

Potential applications of an embodiment of the present invention include, but are not limited to:

1. A user is a person who wants to retain privacy and not be able to be identified but wants relevant advertising from a server(s) tasked with delivering relevant messages. Instead of interacting with the content company directly and experiencing ads served by in-house or outsourced ad servers the user logs onto the new service and is guaranteed anonymity. He stills sees adverts but these are served to the ‘cluster’ or like users.
2. A user is a machine/application that wants resources from another machine/application. The application could be a mobile phone. The mapping or mobile number to device number or identity to a specific stream is never revealed to the service infrastructure.
3. A user is a device consuming a service provided by a remote WiFi wireless access point, with at least partial anonymity being provided for the access point. In this example anonymity is working in the opposite direction to above examples, with the service provider node being anonymised during an interaction with a user entity.
4. Applications of the processes and techniques described will include the certainty of obfuscation of individual identity of persons or processes where there is a legal requirement for protection of identity. Medical records is one such example. Doctors treat individuals but the diagnosis is made with respect to combinations of factors which are usually not unique. A patient may present with extreme stomach ache, no history of pain, but having been on a sea cruiseliner. His experience is individual and his full records are private but the diagnosis focuses on the common experience of his fellow travellers in contracting a virus. Other applications include manipulating patient records to ‘mine’ data for various purposes. The techniques ensure protection of an individual by policing the group size to ensure it is greater than a desired number.
5. Groups of characteristics sufficiently useful to allow commercial exploitation for targeting of advertising and direct marketing or other commercial activities may include general location information, country or county or town. As mobile networks begin to use higher bandwidth smaller sized ‘cells’ the potential exists for these groupings to infringe individual privacy when location is added as a characteristic. Many people content to be potentially anonymous in a large group of online users worry more about being able to be isolated by targeting techniques when using mobile devices. The mobile networks layer information collection and delivery protocols on top of the ‘circuit switched’ networks required to establish voice call connections. These information services and providers and users of them are likely to draw comfort from the policed and enforced anonymity provided by the processes described. For example, instead of being the only person on a street in London to be a member of a dynamically assembled group as described, the software will include, dynamically, other neighbouring streets restoring privacy.
6. Brands like Volvo® or Coca Cola® may find that certain groups of characteristics are those which are associated closely with their own product propositions. They may wish to offer groups to which users can ‘connect’ by use of shared or communal cookies or other techniques. The process and techniques allow this to happen and yet to protect individual identity amongst their user base. By examination of the characteristics within the user base so attracted they may be able to further refine their product proposal without product surveys.
7. Voting or expressions of collective opinion can be facilitated where the joining of a group (qua expression of a preference) is formally hidden from the revelation of an individuals identity, albeit that mechanisms can prevent multiple votes or expressions by the same identity.

Information assets can be utilized whilst simultaneously benefitting from the anonymity of the user entity. The clusters created in accordance with embodiments of the invention both hide the identity of a user entity psedonymously and, at the same time allow the economic value of a user entity as part of a group and thus as an individual to be revealed. The number of user entities within a cluster or an intersection of clusters is known. An interaction may have a worth or value, e.g. a monetary value, associated therewith. For example, if used in advertising, there will be a total value that the advertising is worth. Taking the reciprocal of the cluster size, e.g. for a cluster of thirty user entities, each user entity contributes 1/30th to the transaction by their presence, and their presence in the cluster is worth 1/30th of the value of the interaction. Calculating the reciprocal of the number in the cluster thus enables calculation of a financial value per user entity, which can enable each user entity to be paid a share of the value of the advertising in recognition of their contribution in receiving the advertisements. The payment may be monetary or e.g. in ‘points’ that can be accumulated and traded at a later date for a financial reward. This can therefore be considered as relating to “information asset” dealings and identifying the value that an individual represents, allowing personal information assets to be turned into information capital awarded to a user entity. Novel and inventive aspects of embodiments of the invention apply the concept of information assets to online interactions and to anonymised online interactions.

Furthermore, the value of a cluster of a given number of individuals with the same characteristics is potentially independent of the composition of individuals within the cluster. This means that the clusters are fungible over time. This property can be used to construct financial instruments based on the clusters generated by the clustering engine.

The value associated with the interaction or transaction may not be pre-defined. Rather, it is likely to be determined by the number of users, applications, processes and/or devices etc. that are involved in the interaction or transaction. In other embodiments, there may be no value assigned to the interaction/transaction. That is, having a value is a subset of all possibilities (some have no value) or, to put it another way, all interactions/transactions have a value but the value may be zero. The value may not be explicit. There is also scope for a cooperative approach for many people where clusters form and reform in real-time enabling user entities to get their apportioned share. (An analogy might be a cooperative for agricultural produce from multiple small holders. This could happen via a browser provider, or an ISP, a dominant supplier e.g. a large supermarket chain, or any other natural aggregation point. This can be put into practice where the number of participants in the cooperative becomes large enough, fast enough, to enable apportionment to individuals their share of the value they create. Alternatively, there may be a predefined, fixed value associated with the interaction, irrespective of the number of user entities involved.

It is envisaged that in some jurisdictions access must be provided to enable the ID to be revealed. Under controlled conditions, authorised users can be given access to the underlying IDs; for example for regulatory compliance or for law enforcement.

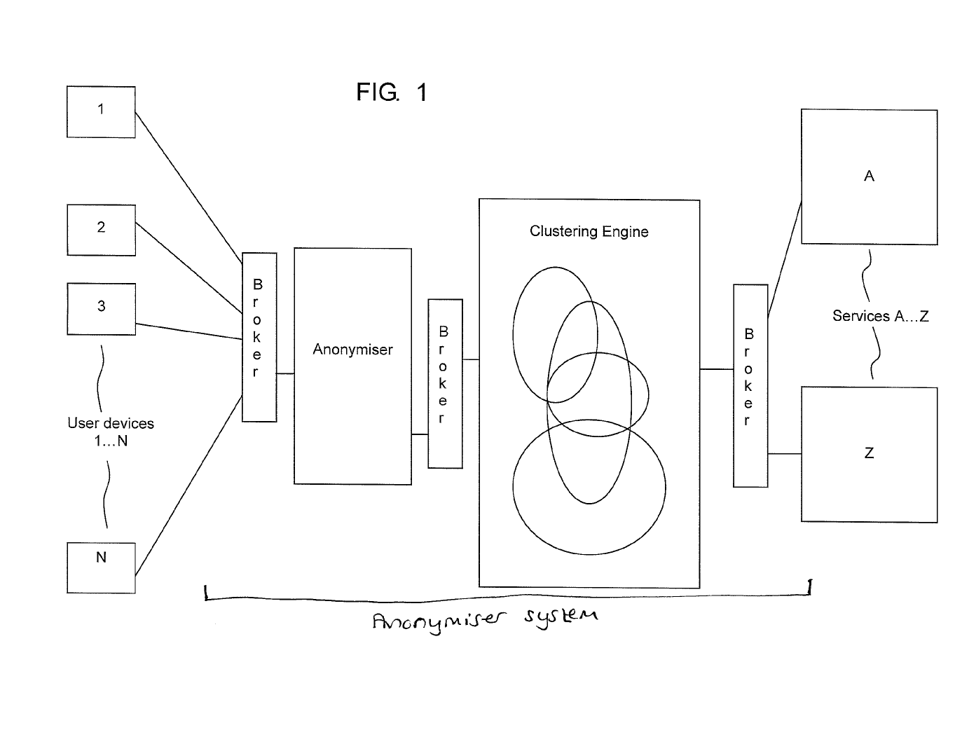

A schematic illustration of a system embodying the present invention is provided in FIG. 1. Applications running on multiple user devices 1 to N, perhaps tablet devices, mobile phones, etc., each potentially running one or more applications, can dialogue with the anonymiser service via one or more information broker services and call for content services A to Z, which may provide content and/or services to the end user applications, but the anonymiser device (as shown in FIG. 1) alone dialogues via an information broker with the clustering engine without revealing the identity of the user(s), the application(s) or the device(s). The clustering engine starts a new dimension to cluster future instances around (for example a new location or a new content type) either in advance of demand by users (human or not) or adds the instance to an existing cluster or clusters. The clusters then act as if they were themselves the initiating user (human or machine) in calling for one or more of the services A to Z. Note that the services may themselves reside on the user devices (p2p applications, or user generated content) and the anonymiser device/clustering engine can themselves be hosted on one device or on several and their function can be distributed throughout the network on user devices or ‘servers’ as required to make the network efficient and to reduce the attack surface for malicious actors. Similarly the services may initiate an interaction by making a request for one or more groups of users with certain characteristics via one or more information broker to the clustering engine. The clustering engine can communicate with the members of the group only via one or more information brokers.

The user device(s) may dialogue with the anonymiser device via one or more trusted information brokers (left hand side of FIG. 1). The service provider(s) may utilise one or more information brokers (right hand side of FIG. 1). Information brokers may be provided by the same company/organisation provided they never co-mingle data on individuals other than through the clustering engine. There may be multiple clustering engines operated by different organisations.

It will be appreciated by the person of skill in the art that various modifications may be made to the above-described embodiments without departing from the scope of the present invention as defined by the appended claims. For example, at least one of the information brokers shown in FIG. 1 can be omitted for certain applications; the information broker between the anonymiser device and the clustering engine may be omitted for example. The information broker in FIG. 1 between the user devices and the anonymiser device can be allowed to choose a suitable anonymiser device from a plurality of available anonymiser devices, and the information broker between the anonymiser device and the clustering engine can be allowed to choose a suitable clustering engine from a plurality of available clustering engines. The anonymiser device and clustering engine may be the same entity, in which case the broker node shown therebetween in FIG. 1 is not needed.

In another embodiment, the user entity(ies) and service provider(s) may be interchanged. This may occur e.g. in the example described above where the user entity is an intermediate entity or process.

WO 02/035314 mentions clustering into anonymous groupings, with the apparent purpose of protecting the user's identity or to “prevent triangulation”, such that a third party “cannot determine, or triangulate, a unique individual from this data”. However, this is actually a very different approach to that according to an embodiment of the present invention. WO 02/035314 does not explicitly count the numbers of people or entities within each grouping, or explicitly count the number in the intersection of those groupings, unlike an embodiment of the present invention. Instead, it appears that WO 02/035314 teaches merely that each piece of information is broadened to such an extent that the “hope” is that the individual can no longer be identified. There is no suggestion that a procedure is adopted according to an embodiment of the present invention to control the population or membership of the various groupings or sets to ensure a minimum number is present in an intersection between the various groupings or sets. It is quite apparent that this information (exact numbers) would not actually be readily available for the examples provided in WO 02/035314 (e.g. the number of foreigners in the US, or the population of the NE of the US, or the number of families with more than one child). There is no teaching in WO 02/035314 as to how triangulation is actually prevented. According to an embodiment of the present invention the numbers are counted precisely to ensure that there is never exactly one (or less than a predetermined low number, which may be two or may be higher) in the intersection—and in one embodiment even populating at least one set with dummy user entities to ensure that the intersection comprises at least the predetermined minimum number of user entities. Counting the number of user entities also enables a value per user entity to be calculated as previously discussed.

Importantly, a feature of embodiments/aspects of the invention is that it is never permitted to allow a subdivision of the set/cluster, or the intersection of multiple sets/clusters that would enable an individual user entity to be identified. As characteristics of user entities are added, the number of user entities in a set decreases because it becomes less likely that all previous members of the set would also have the same newly added characteristics in common. On the other hand, it is desirable to minimise the size of the set such that e.g. targeted advertising is still possible and relevant to the intended recipients. Embodiments/aspects of the invention provide a way to achieve this balance. The set size can be increased/decreased through integer iterations (up or down) to arrive at a beneficial balance. Embodiments of the invention thus provide a test of the cluster/set size e.g. dynamically or in real-time, and adjust the set size to ensure the set is of a sufficient size. The cluster size may change over time, but embodiments of the invention provide for adapting the cluster size such that user entity/service provider needs are met.

The service that is anonymised is, preferably, just a part of the entire interaction that is taking place between the user entity and the service provider, for reasons of practicality and system capabilities, but could, in other embodiments, be the full interaction.

There are several known applications for embodiments and aspects of the invention, and more are becoming apparent. Embodiments of the current invention applies to any online exchange where the protocol that provides content or services is connection oriented, that is to say, if the service requires knowledge of the user or vice versa. Embodiments of the invention allow a safe connection to be made enabling the service to be provided without inadvertent passing of identifiable information, either explicit or inferred.

Smart energy meters can help reduce energy consumption by providing feedback to users and can allow demand management by flexible tariffs and other benefits; but adequate knowledge of use patterns may identify a particular user. This was not the intention of the service provider. And the service provider probably does not require full disclosure of the individual to deliver the benefits of smart metering. In most cases what is important is not the idiosyncrasies, but the similarities of economically valuable groups of users.

Similarly for medical records and genetic records: the idiosyncrasies that make people individuals are less valuable than the similarities of meaningful groups. If services can be provided to research organisations that are privacy protected, much of the inertia facing adoption of medical data record and genetic information sharing can be overcome.

Another use-case would be police and anti-terrorist work. In general, behaviour similar to other known criminals is what is sought, or behaviour anomalous to the group norm. Rather than hold detailed records on individuals, enforcement organisations can be provided services via a “data DMZ” under the control of the users and with access mediated by the Courts, or equivalent.

Facial recognition and CCTV provide powerful new tools for law enforcement, but at the cost of everyone being potentially tracked. The method described in the invention can be used to provide a monitoring system which only highlights the comings and goings of non-registered residents in an apartment block, for example, rather than tracking also all residents movements too. This can be done by considering the characteristics of the facial recognition (or other physical manifestation, gait, etc.) as characteristics that might, in combination, identify just one person. Using the same method, only clusters of similar individuals, tested to ensure reidentifiction would be hard, are available to downstream services, like in-house shopping services etc.

It will be appreciated that operation of one or more of the above-described components can be controlled by a program operating on the device or apparatus. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

1. A method of anonymising an interaction between a user entity comprising a computing device and a service provider node wishing to provide a service via a network to the user entity in dependence upon characteristics of the user entity determined or revealed as a result of the interaction, said interaction having a value associated therewith, the method comprising:
assigning the user entity to at least one set, each set comprising as members a plurality of user entities sharing a characteristic associated with that set;
counting the number of user entities in a said set or in an intersection of the at least one set and calculating a share of said value attributable to each user by dividing the value by the number of user entities in the set;
ensuring that said set or the intersection of the at least one set comprises at least a predetermined minimum number of user entities; and
providing to the service provider node, as part of the interaction, information relating to the or each characteristic associated with each set, the information being for use at the service provider node in providing the service to the user entity, as part of the interaction, that is appropriate in view of the characteristics of the user entity but insufficient to identify the user entity;
wherein the assigning, ensuring and providing steps are performed at an anonymiser system disposed on a communication path between the user entity and the service provider node, the anonymiser system comprising a cooperation of nodes, wherein anonymised service is provided to the user entity via the anonymiser system as part of the interaction between the user entity and the service provider.

2. A method as claimed in claim 1, further comprising keeping a record of the number of user entities.

3. A method as claimed in claim 1, wherein the value associated with the interaction is a monetary value or is associated with a monetary value.

4. A method as claimed in claim 1, comprising populating at least one set with dummy user entities to ensure that the intersection comprises at least the predetermined minimum number of user entities.

5. A method as claimed in claim 1, comprising populating at least one set with additional user entities and/or one or more additional sets of user entities to ensure that the interaction comprises at least the predetermined minimum number of user entities.

6. A method as claimed in claim 1, comprising merging two sets to create a larger set.

7. A method as claimed in claim 1, comprising presenting a warning at the user entity if the intersection comprises a number of user entities within a predetermined range.

8. A method as claimed in claim 1, in which an information broker node communicates with a clustering engine node to determine the at least one set to be assigned to the user entity, with the clustering engine node having knowledge of membership of the sets and the information broker node providing to the clustering engine node information sufficient to assign the user entity to the at least one set.

9. A method as claimed in claim 8, wherein the clustering engine node acts on abstractions of identities the translation of which to real identities is not known by the clustering engine node.

10. A method as claimed in claim 8, wherein the information broker node maintains information sufficient to identify the user entity without retaining knowledge of the characteristics of the user entity.

11. A method as claimed in claim 8, wherein the information broker node is distributed across a plurality of nodes.

12. A method as claimed in claim 1, comprising maintaining a record of user entity membership for each set, and updating the membership of the at least one set when the user entity is assigned to the at least one set.

13. A method as claimed in claim 1, wherein at least some of the steps are performed at a node, or a cooperation of nodes, disposed on a communication path between the user entity and the service provider node.

14. A method as claimed in claim 13, wherein the service is provided to the user entity via the node or cooperation of nodes.

15. A method as claimed in claim 1, comprising, on request of the user entity, allowing the user entity to be identified to another user entity in the at least one set.

16. A method as claimed in claim 1, comprising, on request of the user entity, allowing the user entity to be identified to the service provider node.

17. A method as claimed in claim 1, comprising providing a service to the user entity in dependence upon the information.

18. A method as claimed in claim 1, wherein the service comprises sending data to the user entity.

19. A method as claimed in claim 18, wherein the data comprise media content.

20. A method as claimed in claim 18, wherein the data comprise advertising content.

21. A method as claimed in claim 1, wherein the predetermined minimum number is at least three.

22. A method as claimed in claim 1, wherein the predetermined minimum number is at least ten.

23. A method as claimed in claim 1, wherein the predetermined minimum number is at least 100.

24. A method as claimed in claim 1, comprising determining the predetermined number in real-time.

25. A method as claimed in claim 1, wherein the user entity comprises a device.

26. A method as claimed in claim 25, wherein the characteristics comprise at least one of the hardware capabilities of the device, software capabilities of the device, and location of the device.

27. A method as claimed in claim 1, wherein the user entity comprises a user of a device.

28. A method as claimed in claim 27, wherein the characteristics comprise personal information relating to the user, such as an indication of at least one of the age, gender, home address, postcode, salary, likes, and dislikes of the user, genetic data, physical appearance characteristics, key words used in communications by the user, energy usage.

29. An apparatus for anonymising an interaction between a user entity comprising a computing device and a service provider node wishing to provide a service via a network to the user entity in dependence upon characteristics of the user entity determined or revealed as a result of the interaction, said interaction having a value associated therewith, the apparatus comprising: an anonymiser system configured to assign the user entity to at least one set, each set comprising as members a plurality of user entities sharing a characteristic associated with that set; a counting device for counting the number of user entities in a said set or in an intersection of the at least one set and calculating a share of said value attributable to each user by dividing the value by the number of user entities in the set; the anonymiser system being configured for ensuring that said set or the intersection of the at least one set comprises at least a predetermined minimum number of user entities; and the anonymiser system being configured for providing to the service provider node, as part of the interaction, information relating to the or each characteristic associated with the at least one set, the information being for use at the service provider node in providing a service to the user entity, as part of the interaction, that is appropriate in view of the characteristics of the user entity but insufficient to identify the user entity; wherein the anonymiser system is disposed on a communication path between the user entity and the service provider node, the anonymiser system comprising a cooperation of nodes, wherein anonymised service is provided to the user entity via the anonymiser system as part of the interaction between the user entity and the service provider.

30. An apparatus as claimed in claim 29, wherein the counting engine is configured to keep a record of the number of user entities.

31. An apparatus as claimed in claim 29, wherein the counting engine is part of the clustering engine.

32. A program for controlling an apparatus to perform a method as claimed in claim 1.

33. A program as claimed in claim 32, carried on a carrier medium.

34. A program as claimed in claim 33, wherein the carrier medium is a storage medium.

35. A program as claimed in claim 33, wherein the carrier medium is a transmission medium.

36. An apparatus programmed by a program as claimed in claim 33.

37. A storage medium containing a program as claimed in claim 33.
